(19) United States
(12) Patent Application Publication
(10) Pub. No.: US 2010/0270397 A1
(43) Pub. Date: Oct. 28, 2010

(54) ELECTRIC FAN WITH WATER ATOMIZER

(76) Inventor: Jung-Hua Lin, Taichung Hsien (TW)

Correspondence Address: Muncy, Geissler, Olds & Lowe, PLLC, 4000 Legato Road, Suite 310, FAIRFAX, VA, 22033, US

(21) Appl. No.: 12/431,266

(22) Filed: Apr. 28, 2009

(51) Int. Cl. B05B 3/02; B67D 5/44; B05B 9/04

(52) U.S. Cl. 239/214.25; 222/333; 239/332

(57) ABSTRACT

The present invention provides an electric fan with an atomizer. The electric fan includes a stand, a motor, a web, a fan blade within the web and connected to the motor. The water atomizer includes a base member mounted on a front of the web, a rotary member on a front of the base member, a water impact fence surrounding the rotary member, a gear box on a back of the base member and connected to the rotary member, a flexible transmission member connected to the gear box and the motor of the electric fan that the rotary member is driven by the motor, and a water container receiving water therein that the rotary member has at least a portion sinking in the water of the water container.

### BACKGROUND OF THE INVENTION

1. Field of the Invention

The present invention relates generally to an electric fan, and more particularly to an electric fan with a water atomizer.

2. Description of the Related Art

FIG. 1 shows a conventional electric fan I equipped with a water atomizer 2 on a front web thereof. The water atomizer 2 includes a cup-like member 3, a circular web 4 on the member 3, and a rotary member 5 within the web 4. The rotary member is driven by a motor 6 on a back of the member 3 to sputter water to the web 4 for water atomization, and the electric fan I will blow the atomized water out to enhance the cooling capacity.

A desired speed of the rotary member 5 is different from the electric fan 1 that such electric fan 1 usually has two motors, one for the electric fan 1 and one for the water atomizer 2. Besides, such electric fan 1 has a tank 7 on a base thereof, and a pump 8 in the tank 7 to pump water to the water atomizer 2. The tank 7 and the pump 8 make the electric fan 1 very heavy and expensive.

### SUMMARY OF THE INVENTION

The primary objective of the present invention is to provide an electric fan with a water atomizer, which has no tank and pump like the conventional device.

According to the objective of the present invention, an electric fan includes a stand, a motor, a fan blade connected to the motor, and a water atomizer in front of the fan blade. The water atomizer includes a rotary member, a water impact fence surrounding the rotary member, a gear box connected to the rotary member, a flexible transmission member connected to the gear box and the motor of the electric fan that the rotary member is driven by the motor, and a water container to receive water therein that the rotary member has at least a portion sinking in the water of the water container.

### BRIEF DESCRIPTION OF THE DRAWINGS

FIG. 1 is a perspective view of the conventional electric fan with the water atomizer;

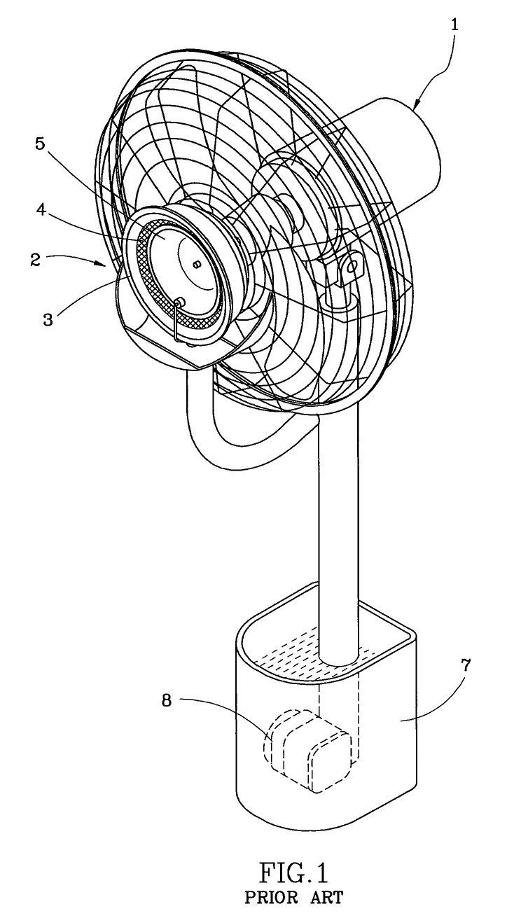

FIG. 2 is a perspective view of a preferred embodiment of the present invention; and

FIG. 3 is a perspective view of a part of the preferred embodiment of the present invention.

### DETAILED DESCRIPTION OF THE INVENTION

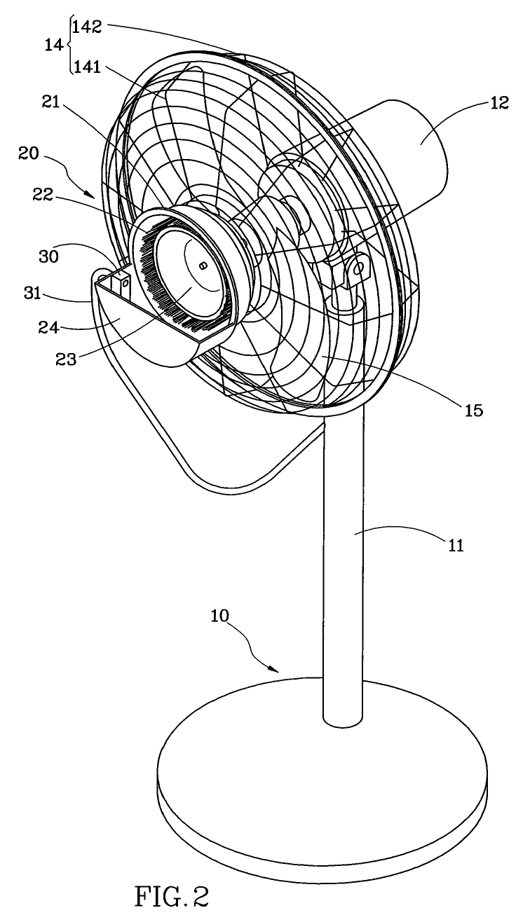

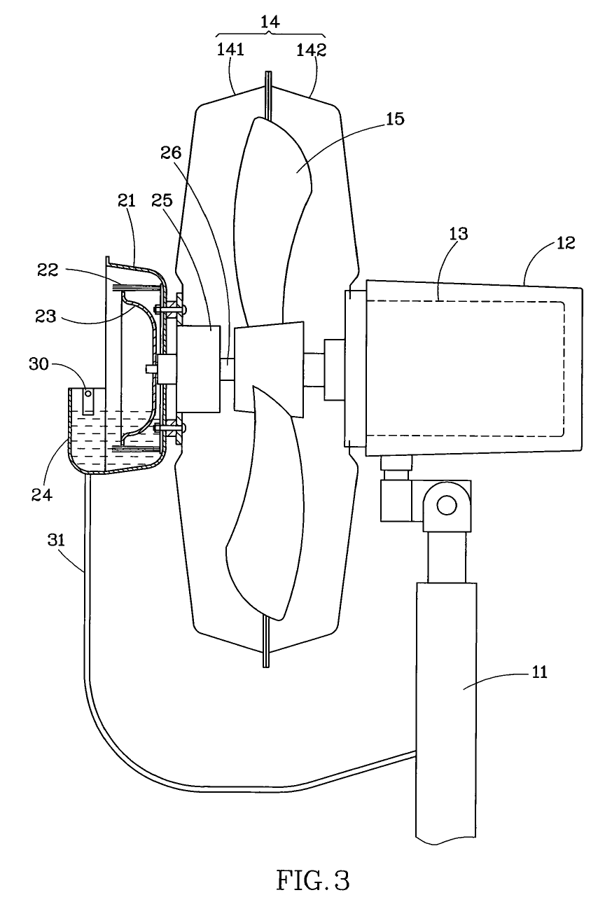

As shown in FIG. 2 and FIG. 3, an electric fan 10 has a stand 11, a case 12 on a top of the stand II, a motor 13 received in the case 12, a web 14, including a front web 141 and a rear web 142, fixed to the case 12, an a fan blade 15 within the web 14 and connected to the motor 13. An atomizer 20 is fixed to the front web 141.

The atomizer 20 includes a cup-like base member 21 fixed to the front web 141. A water impact fence 22 fixed to a front of the base member 21. The water impact fence 22 is a web like member. A rotary member 23 is provided with the water impact fence 22. Aforesaid elements are as same as the conventional devices, and the following is the new design of the present invention:

A gear box 25 is mounted on a back of the base member 21 and is connected to the rotary member 23. A flexible transmission member 26 connects the gear box 25 and the motor 13 of the electric fan 10 that the motor 13 may rotate the rotary member 23.

The base member 21 has a water container 24 on a bottom thereof. The water container 24 is a L-shaped wall on the bottom of the base member 21 to receive water therein. The rotary member 23 has a portion sinking in the water of the water container 24 that the spinning the rotary member 23 will sputter the water in the water container 24 to the water impact fence 22, and the water impact fence 22 will atomize the water and the atomized water will be blown out by the fan blade 15.

A water valve controller 30 is mounted in the water container 24. The water valve controller 30 includes a valve and a sensor. A hose 31 is connected to the water valve controller 30 and a faucet to fill the water container 24.

The obvious character of the present invention is that no water tank and pump on a bottom of the stand 11. The water drops, which are not atomized and blown out, will flow back to the water container 24 directly that no hopper is needed in the present invention to collect the unatomized water drops. Besides, the rotary member 23 is driven by the motor 13 through the flexible transmission member 26 and the gear box 25 that only one motor is needed in the present invention.

When a water level in the water container 24 is lower than a preset level of the sensor of the water valve controller 30, the water valve is open to fill the water container 24, and the water valve is closed when the water level reach the preset level to keep the rotary member 23 always having a portion sinking in the water.

In conclusion, the atomizer 20 of the present invention needs no water tank and pump on the bottom of the stand 11 that the size and weight of the electric fan 10 of the present invention is reduced, and the cost is lower also.

What is claimed is:

1. An electric fan with an atomizer, wherein the electric fan includes a stand, a motor, a fan blade connected to the motor, and the water atomizer, which is provided in front of the fan blade, includes a rotary member, a water impact fence surrounding the rotary member, a gear box connected to the rotary member, a flexible transmission member connected to the gear box and the motor of the electric fan that the rotary member is driven by the motor of the electric fan, and a water container receiving water therein that the rotary member has at least a portion sinking in the water of the water container.

2. The electric fan with the atomizer as defined in claim 1, wherein the atomizer further includes a base member, on which the water container is provided.

3. The electric fan with the atomizer as defined in claim 1, wherein the water container is integrated with the base member.

4. The electric fan with the atomizer as defined in claim 1, wherein the water container is a L-shaped wall projected from the base member.

5. The electric fan with the atomizer as defined in claim 1, wherein the water container is mounted on a bottom of the base member.

6. The electric fan with the atomizer as defined in claim 1, wherein the atomizer further includes a water valve controller, which is received in the water container, having a water valve and a sensor, and a hose connected to the water valve controller and a faucet.
